(19) United States
(12) Patent Application Publication
(10) Pub. No.: US 2022/0044112 A1
(43) Pub. Date: Feb. 10, 2022

(54) Performing Synchronization in the Background for Highly Scalable Distributed Training

(71) Applicant: Facebook, Inc., Menlo Park, CA (US)

(72) Inventors: Qinqing Zheng, Sunnyvale, CA (US); Bor-Yiing Su, Mountain View, CA (US); Jiyan Yang, Saratoga, CA (US); Alisson Gusatti Azzolini, San Francisco, CA (US); Qiang Wu, Houston, TX (US); Ou Jin, Fremont, CA (US)

(21) Appl. No.: 16/989,131

(22) Filed: Aug. 10, 2020

(51) Int. Cl. G06N 3/08; G06N 3/04

(52) U.S. Cl. CPC G06N 3/08; G06N 3/04

(57) ABSTRACT

In one embodiment, a method for training a machine-learning model having multiple parameters includes instantiating trainers each associated with at least a worker thread, a synchronization thread, and a local version of the parameters, using the worker threads to perform training operations that comprise generating an updated local version of the parameters for each trainer using its associated worker thread, while the worker threads are performing training operations, using the synchronization threads to perform synchronization operations that comprise generating a global version of the parameters based on the updated local versions of the parameters and generating a synchronized local version of the parameters for each trainer based on the global version, continuing performing training operations based on the synchronized local versions of the parameters, and determining the parameters at the end of training based on at least a final local version of the parameters associated with one trainer.

### TECHNICAL FIELD

This disclosure generally relates to computing optimization, and in particular relates to machine-learning model training in computing optimization.

### BACKGROUND

Distributed systems are groups of networked computers which share a common goal for their work. The terms “concurrent computing”, “parallel computing”, and “distributed computing” have a lot of overlap, and no clear distinction exists between them. A distributed system is a system whose components are located on different networked computers, which communicate and coordinate their actions by passing messages to one another. The components interact with one another in order to achieve the common goal. The same system may be characterized both as “parallel” and “distributed”; the processors in a typical distributed system run concurrently in parallel. Parallel computing may be seen as a particular tightly coupled form of distributed computing, and distributed computing may be seen as a loosely coupled form of parallel computing. In parallel computing, all processors may have access to a shared memory to exchange information between processors. In distributed computing, each processor has its own private memory (distributed memory). Information is exchanged by passing messages between the processors.

Deep learning (also known as deep structured learning or differential programming) is part of a broader family of machine learning methods based on artificial neural networks with representation learning. Learning can be supervised, semi-supervised or unsupervised. Deep learning architectures such as deep neural networks, deep belief networks, recurrent neural networks and convolutional neural networks have been applied to fields including computer vision, speech recognition, natural language processing, audio recognition, social network filtering, machine translation, bioinformatics, drug design, medical image analysis, material inspection and board game programs, where they have produced results comparable to and in some cases surpassing human expert performance.

### SUMMARY OF PARTICULAR EMBODIMENTS

Distributed training is useful to train complicated models to shorten the training time. As each of the workers only sees a small fraction of data, workers need to synchronize on the parameter updates. One of the central questions in distributed training is how to parsimoniously synchronize parameters while preserving model quality. To address this problem, the embodiments disclosed herein isolate synchronization from training and run it in the background. In contrast to common strategies including synchronous stochastic gradient descent (SGD), asynchronous SGD, and model averaging on independently trained sub-models, where synchronization happens in the foreground, the embodiments disclosed herein are neither part of the backward pass, nor happens every k iterations. The embodiments disclosed herein may be generic to host various types of synchronization algorithms, and we propose 3 approaches under this theme. The advantage of the embodiments disclosed herein is confirmed by experiments on training deep neural networks for click-through-rate prediction. The embodiments disclosed herein all succeed in making the training throughput linearly scale with the number of trainers. Comparing to their foreground counterparts, the embodiments disclosed herein exhibit neutral to better model quality and better scalability when we keep the number of parameter servers the same. In our training system which expresses both replication and Hogwild parallelism, the embodiments disclosed herein also accomplish the highest example level parallelism number comparing to the prior arts.

In particular embodiments, a computing system may train a machine-learning model having a plurality of parameters as follows. The computing system may instantiate trainers that are each associated with at least a worker thread, a synchronization thread, and a local version of the parameters. In particular embodiments, the computing system may use the worker threads to perform training operations. The training operations may comprise generating, for each of the trainers, an updated local version of the parameters using the worker thread associated with that trainer. While the worker threads are performing training operations, the computing system may use the synchronization threads to perform synchronization operations. In particular embodiments, the synchronization operations may comprise generating a global version of the parameters based on the updated local versions of the parameters and generating, for each of the trainers, a synchronized local version of the parameters based on the global version of the parameters. In particular embodiments, the computing system may continue performing training operations based on the synchronized local versions of the parameters. The computing system may further determine, at the end of training, the parameters for the machine-learning model based on at least a final local version of the parameters associated with one of the trainers.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, may be claimed in another claim category, e.g. system, as well. The dependencies or references back in the attached claims are chosen for formal reasons only. However any subject matter resulting from a deliberate reference back to any previous claims (in particular multiple dependencies) may be claimed as well, so that any combination of claims and the features thereof are disclosed and may be claimed regardless of the dependencies chosen in the attached claims. The subject-matter which may be claimed comprises not only the combinations of features as set out in the attached claims but also any other combination of features in the claims, wherein each feature mentioned in the claims may be combined with any other feature or combination of other features in the claims. Furthermore, any of the embodiments and features described or depicted herein may be claimed in a separate claim and/or in any combination with any embodiment or feature described or depicted herein or with any of the features of the attached claims.

### BRIEF DESCRIPTION OF THE DRAWINGS

FIG. 1 illustrates an example architecture of the deep learning recommendation model.

FIG. 2 illustrates an example architecture of the system of the embodiments disclosed herein.

FIG. 3 illustrates an example optimization of the embedding tables by worker threads for model parallelism.

FIG. 4A illustrates an example visualization of the disclosed framework for data parallelism optimization for centralized algorithms.

FIG. 4B illustrates an example visualization of the disclosed framework for data parallelism optimization for decentralized algorithms.

FIG. 5A illustrates example scaling behavior of S-EASGD and FR-EASGD for training Model-B on Dataset-2 based on EPS and number of trainers.

FIG. 5B illustrates example scaling behavior of S-EASGD and FR-EASGD for training Model-B on Dataset-2 based on training loss and number of trainers.

FIG. 5C illustrates example scaling behavior of S-EASGD and FR-EASGD for training Model-B on Dataset-2 based on evaluation loss and number of trainers.

FIG. 5D illustrates example scaling behavior of S-EASGD and FR-EASGD for training Model-B on Dataset-2 in which saturation problem of the sync PSs is solved by increasing the number of the sync PSs.

FIG. 6A illustrates example model quality of BMUF and MA under the disclosed framework and fixed rate frameworks for training Model-B on Dataset-2.

FIG. 6B illustrates example EPS scaling of BMUF and MA algorithms.

FIG. 7A illustrates example performance of S-EASGD for training Model-B on Dataset-2.

FIG. 7B illustrates example performance of S-BMUF for training Model-B on Dataset-2.

FIG. 7C illustrates example performance of S-MA for training Model-B on Dataset-2.

FIG. 8A illustrates example performance of S-EASGD based on loss with varying number of worker threads for training Model-C on Dataset-3.

FIG. 8B illustrates example performance of S-EASGD based on EPS with varying number of worker threads for training Model-C on Dataset-3.

FIG. 9 illustrates an example method for training a machine-learning model having a plurality of parameters.

FIG. 10 illustrates an example computer system.

### DESCRIPTION OF EXAMPLE EMBODIMENTS

Distributed training is useful to train complicated models to shorten the training time. As each of the workers only sees a small fraction of data, workers need to synchronize on the parameter updates. One of the central questions in distributed training is how to parsimoniously synchronize parameters while preserving model quality. To address this problem, the embodiments disclosed herein isolate synchronization from training and run it in the background. In contrast to common strategies including synchronous stochastic gradient descent (SGD), asynchronous SGD, and model averaging on independently trained sub-models, where synchronization happens in the foreground, the embodiments disclosed herein are neither part of the backward pass, nor happens every k iterations. The embodiments disclosed herein may be generic to host various types of synchronization algorithms, and we propose 3 approaches under this theme. The advantage of the embodiments disclosed herein is confirmed by experiments on training deep neural networks for click-through-rate prediction. The embodiments disclosed herein all succeed in making the training throughput linearly scale with the number of trainers. Comparing to their foreground counterparts, the embodiments disclosed herein exhibit neutral to better model quality and better scalability when we keep the number of parameter servers the same. In our training system which expresses both replication and Hogwild parallelism, the embodiments disclosed herein also accomplish the highest example level parallelism number comparing to the prior arts.

In particular embodiments, a computing system may train a machine-learning model having a plurality of parameters as follows. The computing system may instantiate trainers that are each associated with at least a worker thread, a synchronization thread, and a local version of the parameters. In particular embodiments, the computing system may use the worker threads to perform training operations. The training operations may comprise generating, for each of the trainers, an updated local version of the parameters using the worker thread associated with that trainer. While the worker threads are performing training operations, the computing system may use the synchronization threads to perform synchronization operations. In particular embodiments, the synchronization operations may comprise generating a global version of the parameters based on the updated local versions of the parameters and generating, for each of the trainers, a synchronized local version of the parameters based on the global version of the parameters. In particular embodiments, the computing system may continue performing training operations based on the synchronized local versions of the parameters. The computing system may further determine, at the end of training, the parameters for the machine-learning model based on at least a final local version of the parameters associated with one of the trainers.

Improving model quality is a race that never ends. In order to accomplish the goal, machine learning practitioners often train with more and more data, use more and more features, or innovate on the model architecture to capture more meaningful interactions among the features. However, both increasing data and increasing model complexity have direct impact on the training speed. As a result, to finish the training job in a reasonable amount of time, distributed training becomes inevitable for training complicated models on large dataset.

Unfortunately, distributed training is extremely challenging. In practice, most of the training algorithms are based on stochastic gradient descent (SGD). However, SGD is a sequential algorithm. When we express parallelism on SGD, often times we are breaking the sequential update assumption and maintaining good model convergence is difficult. With that, there are many works that propose various ideas to improve training speed while preserving model convergence quality. These ideas are based on different synchronization strategies, to define how different workers synchronize with each other and update the parameters.

To the best of our knowledge, all the existing synchronization algorithms may have incorporated synchronization in the training loop. However, having synchronization as part of the training loop may tend to make it an overhead in training. Usually to ensure good training convergence, we may need to synchronize often. The more often we synchronize, the more time we may spend on synchronization and hence it may increase the end-to-end training time. This can be manifested by the fact that there is much active research attention on quantization and gradient sparsification in order to reduce the synchronization overhead. For example, the ternary gradient, deep compression and one-bit quantization work claim 3×, 4× and 10× training speedup by reducing the communication cost.

The embodiments disclosed herein perform synchronization in the background, so that the synchronization does not interfere the foreground training process. With that, the embodiments disclosed herein may be able to achieve linear scalability in terms of EPS (Definition 1). The embodiments disclosed herein have also empirically validated that the model quality is on par with or better than the case when we sync in the foreground.

Definition 1 (Examples Per Second). We define Examples Per Second (EPS) as the number of examples per second processed by the distributed training system. This is the primary metric we will use to measure the training performance.

Even though the idea of the embodiments disclosed herein is widely applicable to any model architectures, the embodiments disclosed herein focus on click-through-rate prediction models that are similar to the deep learning recommendation model (DLRM) architecture. The embodiments disclosed herein focus on illustrating how to integrate the disclosed framework to the distributed training system that can train DLRM-like models. In our distributed training system, we express both model parallelism and data parallelism for training, and hogwild parallelism and replication parallelism for optimization. With that, the embodiments disclosed herein are able to get the highest ELP (Definition 2) number among all the prior arts to the best of our knowledge.

Definition 2 (Example Level Parallelism). We define Example Level Parallelism (ELP) as the maximum number of examples processed by the distributed training system concurrently at any point of training time.

The main contributions of the embodiments disclosed herein are in the following:

1) The embodiments disclosed herein introduce a new framework to synchronize parameters in the background. The framework may be generic to host various synchronization algorithms. In essence, it splits the duty of synchronization and training and thus is flexible to accommodate new algorithms in the future.

2) The embodiments disclosed herein present improved elastic averaging SGD (EASGD), improved blockwise model-update filtering (BMUF), and improved model averaging (MA) algorithms (EASGD, BMUF, and MA are all conventional work) which all sync parameters in the background. This shows how simple it is to develop new synchronization algorithms in the disclosed framework.

3) The embodiments disclosed herein empirically demonstrate that the disclosed idea may enable us to scale training EPS linearly because training is not interrupted by syncing. When we increase the scale of training, we see the embodiments disclosed herein outperform the foreground variants in both the relative error changes and the absolute error metrics.

4) The embodiments disclosed herein compare the improved algorithms using the disclosed framework, and conclude that all of them have the same training EPS, while improved EASGD has slightly better quality, and improved BMUF/MA consume fewer compute resources because they do not need the extra sync parameter servers.

5) The embodiments disclosed herein compare the ELP for our distributed training system with other state-of-the-art works and claim that the embodiments disclosed herein may accomplish the highest ELP among all the distributed training works to the best of our knowledge.

The system in the embodiments disclosed herein is designed to support models in a similar architecture as the Deep Learning Recommendation Model (DLRM). It may be capable of expressing model parallelism and/or data parallelism simultaneously, depending on the specific design of the particular model.

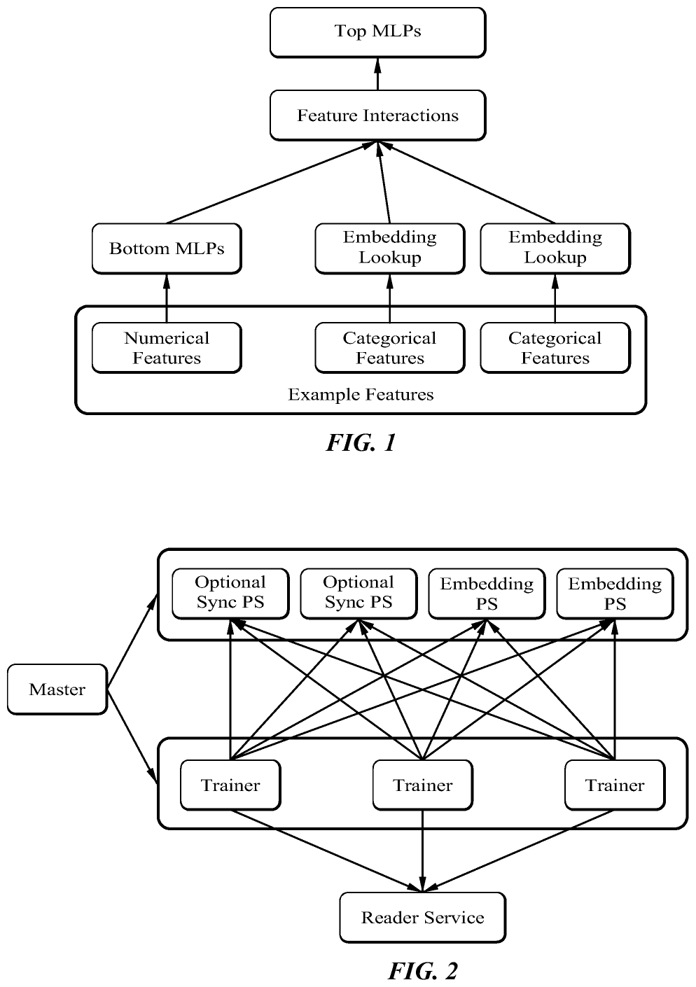

Architecture and Parallelism. FIG. 1 illustrates an example architecture of the deep learning recommendation model. The DLRM is composed of three layers of architectures. The bottom layer contains embedding look up table, in which the categorical features are transformed into embeddings, and a multi-layer perceptron (MLP) that transfers numerical features to embeddings for the next layer. The middle layer is feature interactions, in which the interactions among the embeddings are defined. The top layer is primarily the multi-layer perceptrons (MLPs).

We may have hundreds of embedding tables, and each table may be gigantic. Depending on the category index space and the embedding dimension, one embedding table may range from a few gigabytes to a few terabytes. There is no guarantee that one embedding fits in the memory of one machine. Therefore, we have to express model parallelism and partition the embeddings into smaller shards to fit the shards into the memory of physical machines.

The computation in the interaction layers may be communication heavy. We may need to collect the embedding lookups from different categorical features and the remaining numerical features into one place so that we may perform the interaction operations among all of them. The size of the returned embeddings, the numerical features, and the interaction operations usually do not consume a lot of memory. So we may express data parallelism among them to improve training EPS. For the bottom MLPs and top MLPs, they are usually small in size, in the magnitude of megabytes. So it may be perfectly fine to express data parallelism among them.

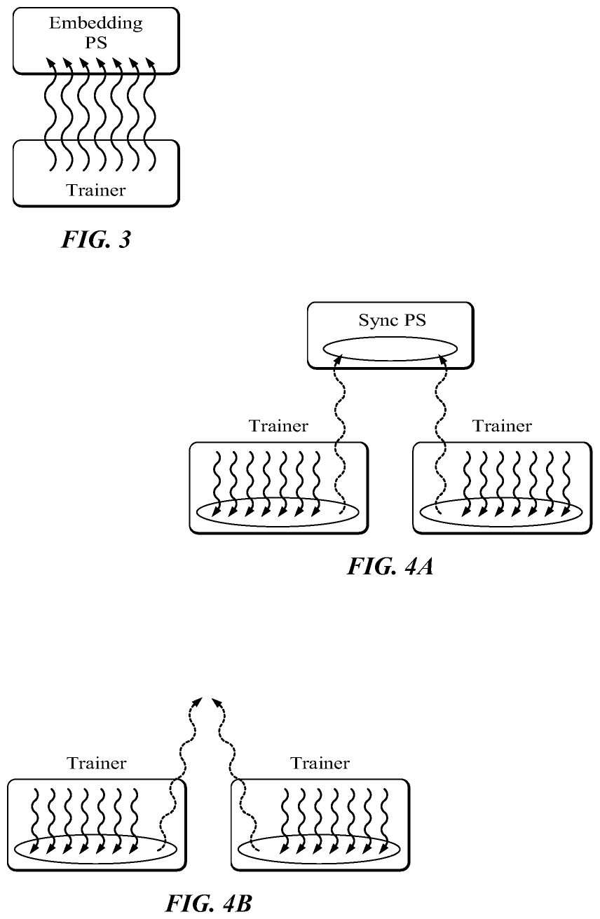

Execution. FIG. 2 illustrates an example architecture of the system of the embodiments disclosed herein. FIG. 2 illustrates that for architectures similar to DLRM, the training of embedding layer happens in the embedding PSs and model parallelism is performed. FIG. 2 also illustrates that the training of interaction and MPL layers happen in the trainers and data parallelism. In particular embodiments, the computing system may generate, by a master, a plurality of partitions of the training of the machine-learning model. The computing system may then send, by the master to each of the trainers, a distinct execution plan for that trainer. In particular embodiments, the distinct execution plan may be determined based on the plurality of partitions. A master coordinates the workers to train a model jointly. Given a pool of workers, it partitions the computation based on the model parallelism and data parallelism strategies, and then sends different execution plans to different workers. The trainers are the workers who control the training loop. In particular embodiments, the trainers may be associated with a shared reader service. The shared reader service may convert a training example to a feature representation used for training the machine-learning model. Each trainer connects to a shared reader service. It has a local queue that fetches new batch of examples from the reader service. The reader service is a distributed system which consumes the raw data in the distributed storage, and then converts the raw data to feature tensors after the feature engineering step so that the trainers can focus on training without being bottlenecked on the data reading.

In particular embodiments, training the machine-learning model may be based on a plurality of training examples. Accordingly, generating the updated local version of the parameters for each of the trainers using the worker thread associated with that trainer may comprise the following steps. The computing system may first partition the plurality of training examples into a plurality of batches of training examples. The computing system may then access one batch of feature representations corresponding to one batch of the plurality of batches of training examples. Finally, the computing system may generate the updated local version of the parameters based on the accessed batch of feature representations. The trainers are multi-threaded and are training multiple batches of examples concurrently. The connection between the trainers and the parameter servers (PS) forms a bipartite graph. Each trainer can connect to each parameter server. Given a batch of examples, one trainer thread sends the embedding lookup requests to the corresponding embedding PSs who host the embedding tables. If one embedding is partitioned into multiple shards and placed on multiple embedding PSs, we may perform local embedding pooling on each PS for the embedding shard, then the partial pooling from the shards may be returned to the trainer to perform the overall embedding pooling to get the final embedding lookup results. Another optimization we have performed on the embedding PSs is to ensure that the workload is distributed evenly among the embedding PSs. We accomplish this goal by profiling the cost of embedding lookup in advance, and then solve a bin packing problem to distribute the workload (the embedding lookup cost) among the embedding PSs (the available bins) evenly. With this optimization, we may be able to ensure that the trainers are not bottlenecked by the shared embedding PSs. The sync PSs are optional and only exist if we use centralized algorithm, e.g. EASGD, as the synchronization algorithm. To balance the load for the sync PSs, we applied the similar optimizations to profile the costs and then solve the bin packing problem to shard and distribute the parameters to the available Sync PSs.

In brief, the embedding lookup is expressed as model parallelism and is executed in the embedding PSs. After all the embedding lookups are returned, the trainer has all the embeddings and the numerical features needed for current mini-batch. The interaction layers and the MLP layers are thus executed in the trainers. This part is expressed as data parallelism in which each trainer thread is processing its own batch of examples in parallel. Similarly, for the backward pass, the gradient calculation and parameter updates for the MLP and the interaction layers are performed in the trainers. Then the trainers send the gradients to the embedding PSs to update the embeddings.

Even though the system is designed with the DLRM in mind, it may be a generic architecture. Basically, we express data parallelism in the trainers, and model parallelism in the PSs. More than that, there may be additional PSs for special purposes (like the sync PSs). The parameter servers may be capable of executing arbitrary operations that are defined by the master. The most common use case may be to perform partial embedding pooling. But if more complicated model is expressed, such as adding attention layer to the embedding lookup, we may also perform the required MLP layers on the embedding PSs as well.

Within a trainer, we have created multiple worker threads to process the example batches in parallel. The simplest idea may be to let one thread process one batch of examples. A more complicated parallelism may be to explore intra-op parallelism, so that we may use multiple threads for executing the layers for one example batch. The embodiments disclosed herein assume that we use one thread to process one example batch. That is, if we have 24 threads, we may process 24 example batches concurrently. Given that we have performed different parallelization strategies for different parts of the model, the optimization strategies for different parts may be also different.

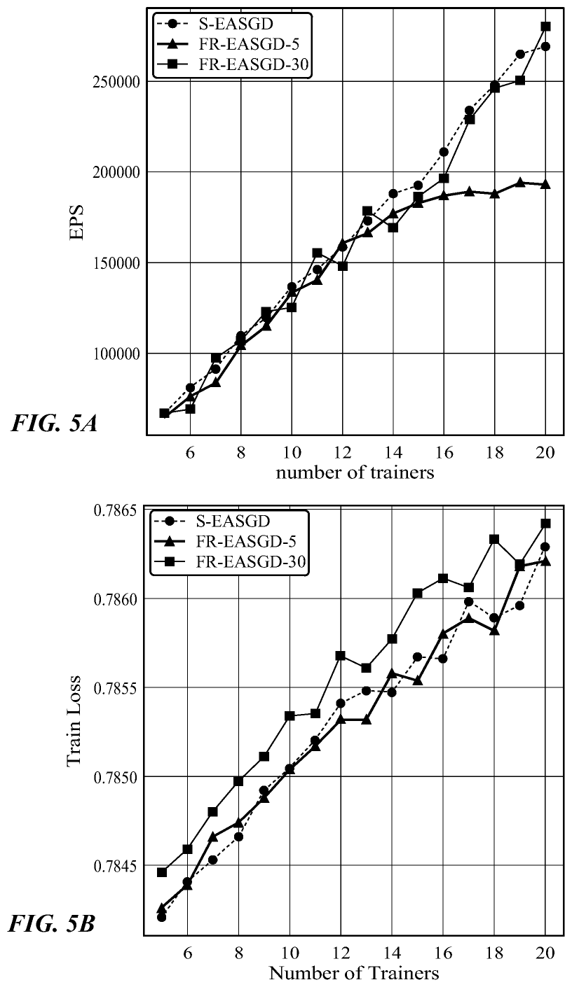

The embedding tables may be big and thus partitioned into many shards and hosted in different embedding PSs. Therefore, there may be only one copy of the embedding tables in the whole system. With that, the embodiments disclosed herein are using the Hogwild algorithm (a conventional work) to optimize the embedding tables. FIG. 3 illustrates an example optimization of the embedding tables by worker threads for model parallelism. There is no lock involved in the accesses of the tables. When an embedding PS receives one request from a trainer, it may be either doing the embedding lookup or the embedding update in a lock-freeway. Every embedding PS may have multiple threads so that it may handle many requests in parallel. Different optimization techniques may be used when updating the embeddings. All the auxiliary parameters for the optimizers may collocate with the actual embeddings on the embedding PSs.

For the interaction and MLP layers, we express data parallelism on them. The parameters for these layers may be replicated across all the trainers. Locally, all the worker threads within one trainer may access the intra-trainer shared parameter memory space, and also the shared auxiliary parameters for the optimizer of choice. These accesses may be performed in a Hogwild manner as well. So the reads and the updates to the local parameters may be lock-free. This strategy has broken the Hogwild assumption that the parameter accesses are sparse. In the case of the embodiments disclosed herein, all the threads may be accessing the same parameters in parallel. In practice, this strategy may work well and still provide very good model convergence.

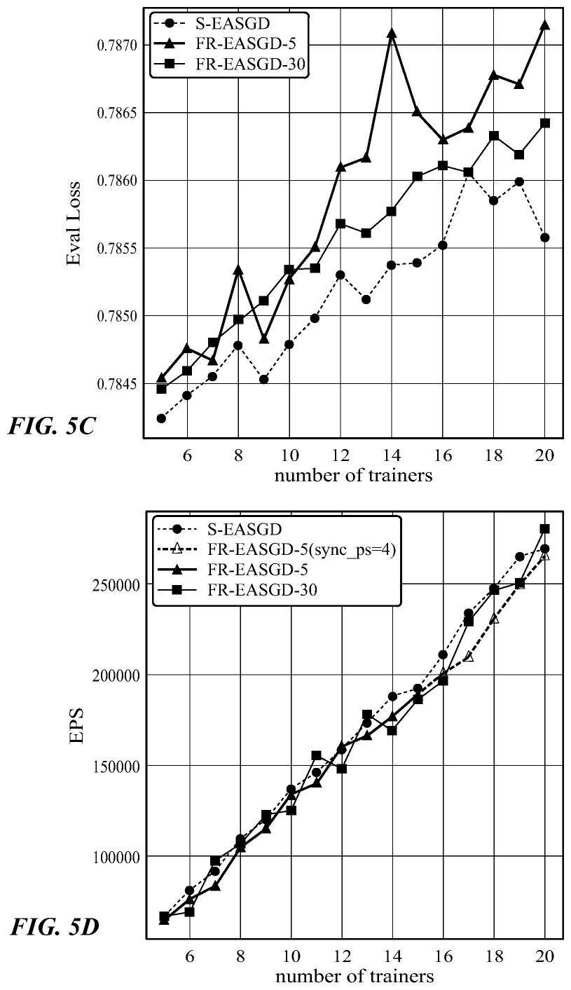

In the model parallelism regime, the worker threads may access the shared parameters in the embedding PSs. In contrast, for the interaction and MLP layers, i.e., data parallelism regime, the scope of worker threads may be restricted to the local parameter space on individual trainer. In order to synchronize among the trainers, the embodiments disclosed herein create one shadow thread, who is independent to the worker threads, to carry out the synchronization without interrupting the foreground training. This background synchronization framework may be referred as ShadowSync. FIG. 4 illustrates an example visualization of the disclosed framework for data parallelism optimization. The solid-line arrows represent worker threads. They update local replica of parameters in the Hogwild manner. The dashed-line arrows represent shadow threads whose job is synchronization. Depending on the specific sync algorithm of choice, the shadow threads may either communicate with each other or just with the sync PSs.

This framework may have a number of appealing properties. First, as we have separated the duty of training and synchronization into different threads, training may be never stalled by the synchronization need. For the computational time and network communication cost, the huge overhead of syncing the parameters may be removed from the training loop. The experiments of the embodiments disclosed herein illustrate that when using two sync PSs, syncing in the foreground became a bottleneck and the training speed plateaued with more than 14 trainers. On the other hand, we may be able to scale linearly with the disclosed framework on the same setting.

Second, the disclosed system may be capable of expressing different sync algorithms. In particular embodiments, generating the global version of the parameters based on the updated local versions of the parameters may be based on one or more synchronization algorithms. Each of the one or more synchronization algorithm may be predetermined independently from the machine-learning model. For the centralized algorithms like EASGD, we may need a place to host the central parameters. In the disclosed architecture, we have chosen to allocate dedicated sync PSs for this purpose. The central parameters may be hosted on the sync PSs, and then the trainers may sync their local replication of the parameters to the sync PSs. In particular embodiments, generating the global version of the parameters based on the updated local versions of the parameters may comprise communicating the updated local versions of the parameters to one or more synchronization parameter servers and synchronizing, at the one or more synchronization parameter servers, the updated local versions of the parameters to generate the global version of the parameters. The synchronization may be a network heavy operation, so the embodiments disclosed herein allow partitioning the parameters into shards, and use multiple sync PSs to sync the parameters. In other words, the computing system may partition the plurality of parameters into one or more shards corresponding to the one or more synchronization parameter servers. In particular embodiments, generating the synchronized local version of the parameters for each of the trainers may comprise communicating, from the one or more synchronization parameter servers to that trainer, the global version of the parameters. The embodiments disclosed herein may also support decentralized algorithms like model averaging or BMUF, for which we do not need central sync PSs. As a result, the embodiments disclosed herein apply the all-reduce collectives to sync among the trainers directly. In other words, generating the global version of the parameters based on the updated local versions of the parameters may be based on communications between each of the synchronization threads.

Last but important, in the practical realization of our system, the development of sync algorithms may be completely separated from training code. This may make the system easy to modify and experiment, without much engineering effort.

TABLE 1
ELP comparison between the disclosed framework
and the other optimization algorithms.

| Algorithm | Batch Size | # Hog. | #Rep. | ELP |
|---|---|---|---|---|
| ShadowSync | 200 | 24 | 20 | 96000 |
| EASGD (conventional | 128 | 1 | 16 | 2048 |
| work) | | | | |
| DC-ASGD (conventional | 128 | 16 | 1 | 2048 |
| work) | | | | |
| BMUF (conventional | N.A. | 1 | 64 | 64 × B |
| work) | | | | |
| DownpourSGD | N.A. | 1 | 200 | 200 × B |
| (conventional work) | | | | |
| ADPSGD (conventional | 128 | 1 | 128 | 16384 |
| work) | | | | |
| LARS (conventional | 32000 | 1 | 1 | 32000 |
| work) | | | | |
| SGP (conventional work) | 256 | 1 | 256 | 65536 |

#Hog. refers to the number of threads who access the shared parameters in a Hogwild fashion. #Rep. refers to the number of replicated parameters in the system.

The two-level data parallelism (Hogwild within a trainer and replication across trainers) we have expressed in training may help us to accomplish very high ELP numbers. In Table 1, we have compared the ELP we have accomplished with other state-of-the-art optimization algorithms. In the experiments of the embodiments disclosed herein, the maximum number of trainers we have used is 20, which seems to be a moderate number. But when we include batch size and the concurrent Hogwild updates, the ELP we are able to accomplish is very high. We have accomplished 96000 ELP with 20 trainers. The batch sizes of the BMUF and the DownpourSGD work (i.e., a conventional work) are not disclosed in their respective disclosures, so their ELP should be the amount of data parallelism they have expressed times B, which is the batch size of training. To the best of our knowledge, the Stochastic Gradient Push work (i.e., a conventional work) may be the best reported distributed training so far. It may scale to 256 GPUs, with each GPU training on a batch of 256 examples. But even with that, the ELP that is accomplished in its disclosure is 65536.

The embodiments disclosed herein further present the formal algorithmic description of the concept of the disclosed framework. Three representative algorithms under this framework are introduced, which incorporate the synchronization strategy of EASGD, model averaging, and BMUF into the execution plan of shadow threads respectively. We call these algorithms Shadow EASGD, Shadow MA and Shadow BMUF.

Let h denote the embedding of categorical features and w denote the weights on MLP and interaction layers. The goal is to minimize the objective function ƒ_{D} (w, h) defined by the model architecture and training data D. In the disclosed framework, assume there are n trainers. Recall there is only one copy of h on the embedding PSs and n replications of w on trainers. Let w⁽ⁱ⁾ denote the replica on trainer i, and D⁽ⁱ⁾ denote the dataset consumed by trainer i. The disclosed system is solving the following optimization problem

$${min}_{{𝓌}^{( 1 )} , … , {𝓌}^{( 𝓃 )} , h} {\sum }_{i = 1}^{n} {f}_{D}^{( i )} ( {𝓌}^{( i )} , h ) , \\ subject to {𝓌}^{( 1 )} , … , {𝓌}^{( 𝓃 )} in sync . \qquad ( 1 )$$

The constraint in Equation 1 is used to promote the consistency across the weight replicas, and different algorithms may use different strategies to derive the sync updates. For example, depending on the topology of the chosen algorithm, the shadow thread on trainer i may sync with replicas on other trainers directly, or indirectly, through a hub copy on the sync PS. When the training ends, one may either output the average of w⁽ⁱ⁾s, select the best replica on a validation dataset, or even simply pick an arbitrary replica. In other words, determining the parameters for the machine-learning model may be further based on an average of all final local versions of the parameters associated with all the trainers. In particular embodiments, there may be multiple ways to define the final parameters for the machine-learning model. In particular embodiments, the local version of the parameters associated with one trainer may be used as the final parameters. In particular embodiments, any suitable aggregation among the local versions of the parameters associated with all the trainers may be used as the final parameters. In particular embodiments, the global version of the parameters may be used as the final parameters.

Algorithm 1 summarizes the idea of the embodiments disclosed herein. The embodiments disclosed herein may first initialize the embedding tables by ho. The initialization of MLP and interaction layers wo may be fed to all the trainers. If we use centralized algorithms, the Sync PSs may need to be present and be initialized by wo too. The worker threads on each trainer may optimize their own local weight and the embedding table in the lock-free manner. In other words, if there are m worker threads spawned per trainer, the embedding h may be updated using nm Hogwild threads across the trainers, and the local copy w⁽ⁱ⁾ may be updated by m Hogwild threads within trainer i. For decentralized algorithms, the update of w⁽ⁱ⁾ may involve copies on other trainers, whereas for centralized algorithms, w⁽ⁱ⁾ may just sync with w^{PS}.

Algorithm 1: ShadowSyac Framework

| 1 | Input: w₀, h₀ | | | |
|---|---|---|---|---|
| 2 | Init embedding tables on embedding PSs: h ← h₀ | | | |
| 3 | (Optional) Init MLP & interaction params on sync PSs: w^{PS} ← w₀ | | | |
| 4 | trainer i do in parallel with others | | | |
| 5 | \| | Init local MLP and interaction param w⁽ⁱ⁾ ← w₀ | | |
| 6 | \| | worker threads do in parallel | | |
| 7 | \| | \| | while data is not all consumed do | |
| 8 | \| | \| | \| | Update h on embedding PSs |
| 9 | \| | \| | \| | Update local param w⁽ⁱ⁾ |
| 10 | \| | shadow thread do | | |
| 11 | \| | \| | while data is not all consumed do | |
| 12 | \| | \| | \| | Sync local param w⁽ⁱ⁾ with Sync PS or other trainers |

Algorithm 2: Shadow EASGD on Trainer i

| 1 | Input: elastic param α | | |
|---|---|---|---|
| 2 | shadow thread do | | |
| 3 | \| | while data in not all consumed do | |
| 4 | \| | \| | w^{PS} ← (1 − α)w^{PS} + αw⁽ⁱ⁾ |
| 5 | \| | \| | w⁽ⁱ⁾ ← (1 − α)w⁽ⁱ⁾ + αw^{PS} |

Algorithm 3: Shadow MA on Trainer i

| 1 | Input: elastic param α, total number of trainers n | | | |
|---|---|---|---|---|
| 2 | Init MA global param w^{global} ← w₀ | | | |
| 3 | shadow thread do | | | |
| 4 | \| | while data is not all consumed do | | |
| 5 | \| | \| | w^{global} ← w⁽ⁱ⁾ | // make a copy of local param |

| | | | |
|---|---|---|---|
| 6 | \| | \| | w^{global} ← AllReduce(w^{global})/n |
| 7 | \| | \| | w⁽ⁱ⁾ ← (1 − α)w⁽ⁱ⁾ + αw^{global} |

Algorithm 2, 3, 4 describe the synchronization updates of Shadow EASGD, Shadow MA and Shadow BMUF. Contents of worker threads and initialization that are repeating Algorithm 1 are omitted. For MA, each trainer may host an extra copy of weights w^{global}, which may be used to aggregate the training results via AllReduce. Similarly we have w^{copy} and w^{global} for BMUF, where w^{global} may host the global model in sync and w^{copy} may be used for AllReduce. To sync, BMUF defines the difference between the latest averaged model and current w^{global} as the descent direction, then make a step along it. Considering the descent direction as a surrogate gradient, one may incorporate techniques like momentum update and Nesterov acceleration into the updates.

Algorithm 4: Shadow BMUF on Trainer i

| 1 | Input: step size η, elastic param α, total number of trainers n | | | |
|---|---|---|---|---|
| 2 | Init BMUF global param w^{global}, w^{copy} ← w₀ | | | |
| 3 | shadow thread do | | | |
| 4 | \| | while data is not all consumed do | | |
| 5 | \| | \| | w^{copy} ← w⁽ⁱ⁾ | // make a copy of local |
| | | | | param |
| 6 | \| | \| | w^{copy} ← AllReduce(w^{copy})/n | |
| 7 | \| | \| | w^{desc} ← w^{copy} − w^{global} | // compute descent |
| | | | | direction |

| | | | | |
|---|---|---|---|---|
| 8 | \| | \| | /* can do momentum update, | */ |
| | | | Nesterov acceleration etc. | |

| | | | |
|---|---|---|---|
| 9 | \| | \| | w^{global} ← w^{global} + ηw^{desc} |
| 10 | \| | \| | w⁽ⁱ⁾ ← (1 − α)w⁽ⁱ⁾ + αw^{global} |

The sync update of Shadow EASGD may be essentially the same as original EASGD. Given elastic parameter a, it may do convex interpolation between w^{PS} and w⁽ⁱ⁾. Note that the interpolation may be asymmetric: w⁽ⁱ⁾ and w^{PS} are not equal after this update. Intuitively, the PS may be in sync with other trainers, and the worker threads didn't stop training, so that both of them would like to trust their copy of weights. Similar interpolation may be happening for both Shadow MA and Shadow BMUF. This may be a major modification from the original methods. The experiments of the embodiments disclosed herein have verified it may be essential to improve the model quality in the ShadowSync setting. Take MA for example, the AllReduce primitive may be time-consuming and the worker threads would have consumed a fair amount of data in the AllReduce period. If we directly copy the averaged weight w^{global} back, we may lose the updates to the local parameter replicas when the background synchronization is happening in parallel.

Numerical experiments were conducted on training a variety of machine learning models for click-through-rate prediction tasks. All the algorithms were applied to training production models using real data. Due to privacy issues, the detailed description of specific datasets, tasks and model architectures will be omitted in the embodiments disclosed herein, yet the sizes of datasets are reported when presenting the experiments. In the sequel, the embodiments disclosed herein name the internal models and datasets Model-A to Model-C, and Dataset-1 to Dataset-3, respectively. For simplicity, the embodiments disclosed herein refer to the ShadowSync algorithms as S-EASGD, S-BMUF and, S-MA, and refer to the original fixed rate algorithms as FR-EASGD, FR-BMUF, and FR-MA.

To prevent overfitting, the embodiments disclosed herein use one-pass training. After the training ends, the embedding h and the weights replica w⁽¹⁾ on the first trainer are returned as the output model (this is for simplicity, an alternative may be to return the average of all the weight replicas). The hardware configurations are identical and consistent across all the experiments. All the trainers and PSs use Intel 20-core 2 GHz processor, with hyperthreading enabled (40 hyperthreads in total). For network, the embodiments disclosed herein use 25 Gbit Ethernet. The embodiments disclosed herein set 24 worker threads per trainer.

The embodiments disclosed herein compare ShadowSync scheme to fixed rate scheme in the aspects of the model quality and scalability. As the typical pair of competitors, S-EASGD and FR-EASGD are first picked for this set of experiments. The embodiments disclosed herein are interested in answering the following questions:(1) What is the best sync rate of FR-EASGD? What is the average sync rate of S-EASGD, and how does the quality of the model obtained by S-EASGD compare to FR-EASGD? (2) What is the scaling behavior of S-EASGD and FR-EASGD? Could they achieve linear EPS scaling while maintaining model quality? Similar comparison for BMUF and MA algorithms are presented and the embodiments disclosed herein further focus on the comparison of S-EASGD, S-BMUF and S-MA within the ShadowSync framework. S-BMUF and S-MA are typical de-centralized algorithms—the usage of sync PSs is eliminated. Those lightweight optimizers are suitable for scenarios where the computation resource is on a tight budget. We are thus curious about whether the performance of S-BMUF and S-MA are on par with S-EASGD. Finally, the embodiments disclosed herein provide a justification for the choice of 24 Hogwild worker threads in the setup.

The very first thing we are interested is to compare the qualities of models returned by S-EASGD and FR-EASGD. We studied their performance on training Model-A on Dataset-1. This dataset comprises 48, 727, 971, 625 training examples and 1, 001, 887, 500 testing examples. The performance of FR-EASGD might be sensitive to the hyper-parameter sync gap, which is the number of iterations between two synchronizations. We tested 4 values for it: 5, 10, 30, and 100. We shall use FR-EASGD-5 to denote FR-EASGD with sync gap 5, and similarly for other numbers. To be fair in comparison, all the other hyper-parameters such as elastic parameter, learning rate were set the same as in the production setting, for both S-EASGD and FR-EASGD.

The experiment was first carried out in 11 trainers, 12 embedding PSs and 1 sync PS. Table 2(a) reports the training and evaluation losses obtained. The reported loss is an internal metric used as the objective value in recommendation models. It is similar to the normalized entropy introduced by prior art. We also report the average sync gap for S-EASGD, calculated using metrics measured during training:

$$avg sync gap = \frac{num of iterations trained per sec}{num of EASGD syncs per sec} = \frac{EPS / batch size}{sync PSs network usage per sec / size of weight params 𝓌}$$

Table 2(a) shows that the evaluation loss of FR-EASGD kept increasing as the sync gap goes up, the smallest gap 5 achieves the lowest evaluation error. The training loss of FR-EASGD does not show any pattern correlated with sync gap. The average sync gap of S-EASGD is 5.21, very close to 5. For both training and evaluation loss, S-EASGD outperforms FR-EASGD over all tested sync gaps.

In practice, a common pain point for distributed optimization is that training at scale could degrade the model convergence and thus hurt the model quality. While 11 trainers are at moderate scale, we compare the performance of S-EASGD to FR-EASGD for the same task using 20 trainers, 29 embedding PSs and 6 sync PSs.

TABLE 2
Model quality of training Model-A on Dataset-1.

| | | |
|---|---|---|
| Sync Gap | Train Loss | Eval Loss |

(a) 11 trainers

| | | | |
|---|---|---|---|
| S-EASGD | 5.21 | 0.78926 | 0.78451 |
| FR-EASGD | 5 | 0.78942 | 0.78483 |
| | 10 | 0.78937 | 0.78508 |
| | 30 | 0.78942 | 0.78523 |
| | 100 | 0.78969 | 0.78531 |

(b) 20 trainers

| | | | |
|---|---|---|---|
| S-EASGD | 1.008 | 0.78958 | 0.78565 |
| FR-EASGD | 5 | 0.78971 | 0.78565 |
| | 10 | 0.78977 | 0.78589 |
| | 30 | 0.7899 | 0.78491 |
| | 100 | 0.79008 | 0.78557 |

The results are reported in Table 2(b). The best sync gap for FR-EASGD was 30. This suggested that the optimal sync rate may vary over different system configurations; one may need to carefully tune this hyper-parameter for FR-EASGD. The average sync gap for S-EASGD is 1.008. The sync gap was low due to we underspecified the compute resources of the reader service. The data reading becomes the bottleneck and the training slows done. The evaluation performance of S-EASGD is slightly worse than the best FR-EASGD, but comparable to FR-EASGD-5. Our interpretation is that, the hyper parameters we use in this experiment may favor the case when sync gap is about 30. When we reduce the sync gap, the workers may be tightly synced, and the amount of exploration may be reduced. Thus, the final evaluation results are slightly worse for both the S-EASGD and the FR-EASGD-5 cases. One interesting phenomenon is that FR-EASGD-5 and FR-EASGD-100 has comparable evaluation performance. Our experiments suggested that small sync gap may slow down the convergence in the early stage of training, yet it may be beneficial when the training moves towards the end. We conjecture that a time-varying sync gap may be favorable for FR-EASGD under our setting.

Another important property of the distributed optimization algorithms is the scalability. Ideally, as we increase the training scale, we would like to see the EPS to grow linearly as the number of trainers, while the model quality drop is small and tolerable. To explore the scaling behavior, we apply S-EASGD and FR-EASGD to train Model-B on Dataset-2. Dataset-2 is a smaller dataset that contains 3,762,344,639 training examples and 2,369,568,296 testing examples. We vary the number of trainers from 5 to 20. To ensure enough computing resource, we over-specify the number of embedding PSs to be the same as trainers. The number of sync PSs is fixed to be 2. We tested both FR-EASGD-5 and FR-EASGD-30, since sync gap 5 and 30 are the best results obtained in the previous section. As before, we use the same hyper-parameters for both FR-EASGD and S-EASGD for the sake of fairness.

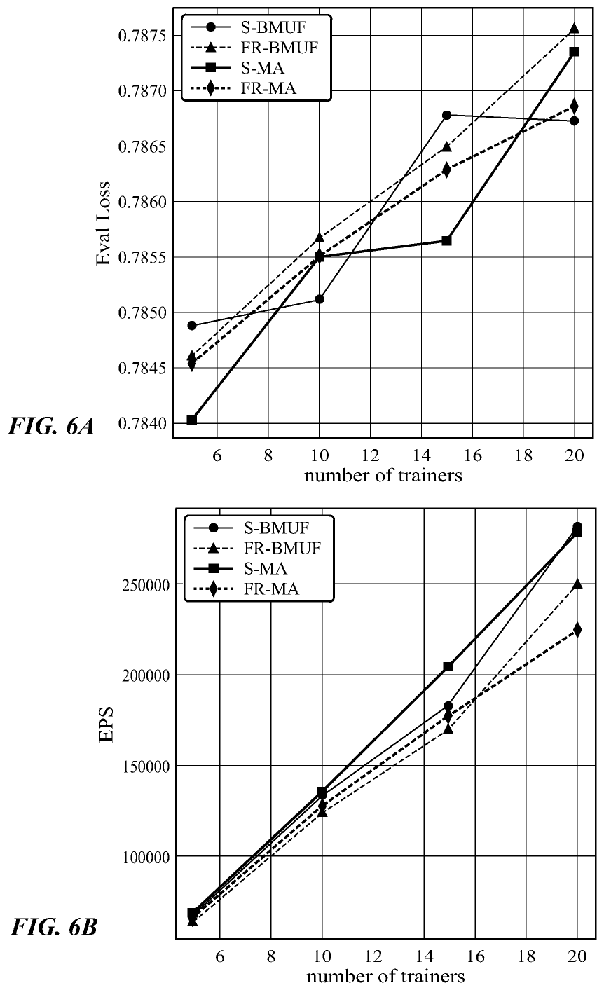

FIGS. 5A-5D illustrate how S-EASGD and FR-EASGD trade model quality for data processing speed. It shows the scaling behavior of S-EASGD and FR-EASGD for training Model-B on Dataset-2. FIG. 5A illustrates example scaling behavior of S-EASGD and FR-EASGD for training Model-B on Dataset-2 based on EPS and number of trainers. FIG. 5A plots EPS as a function of number of trainers, which shows the EPS stagnation of FR-EASGD-5. Both S-EASGD and FR-EASGD-30 achieve linear EPS growth. Yet for FR-EASGD-5, its EPS barely increases after the number of trainers goes up to 14. To explain the reason why FR-EASGD-5 reached this plateau, we investigated the hardware utilization of all the machines and identified the sync PSs as the bottleneck. When more trainers are added into training, the network bandwidths of the sync PSs may be saturated at certain point. For FR-EASGD, the synchronization is foreground and integrated into the training loop, hence the network bandwidth needs may grow as 24× (the number of worker threads) compared to S-EASGD. When the sync gap is small, the sync PSs may easily get saturated. Increasing the number of sync PSs to 4 may solve the problem. We also calculated the average sync gap of S-EASGD as before. For runs with 15-20 trainers, the gaps are 8.60, 8.76, 10.43, 10.93, 11.95, and 12.48. This may also suggest another strength of S-EASGD comparing to FR-EASGD: it may be less demanding for computing resource even for high frequency synchronization. FIG. 5B illustrates example scaling behavior of S-EASGD and FR-EASGD for training Model-B on Dataset-2 based on training loss and number of trainers. FIG. 5C illustrates example scaling behavior of S-EASGD and FR-EASGD for training Model-B on Dataset-2 based on evaluation loss and number of trainers. For S-EASGD and FR-EASGD-30, both training and evaluation loss gently increases in comparable speed, with small fluctuations.

FR-EASGD-5 is not stable in terms of evaluation loss and has some spikes in the curve. In addition, S-EASGD demonstrated the best generalization property. Its evaluation losses are the lowest everywhere. FIG. 5D illustrates example scaling behavior of S-EASGD and FR-EASGD for training Model-B on Dataset-2 in which saturation problem of the sync PSs is solved by increasing the number of the sync PSs.

For each method, we also calculate the relative increase of losses when the number of trainers is 10 and 20, comparing with the 5-trainer case. The results are summarized in Table 3. S-EASGD enjoys the mildest loss increase, especially for evaluation.

TABLE 3
Relative loss increase comparing to the 5-trainer result.

| | | S-EASGD | FR-EASGD-5 | FR-EASGD-30 |
|---|---|---|---|---|
| 10 | Train | 0.084% | 0.099% | 0.096% |
| Trainer | Eval | 0.062% | 0.093% | 0.112% |
| 20 | Train | 0.230% | 0.249% | 0.210% |
| Trainer | Eval | 0.177% | 0.333% | 0.250% |

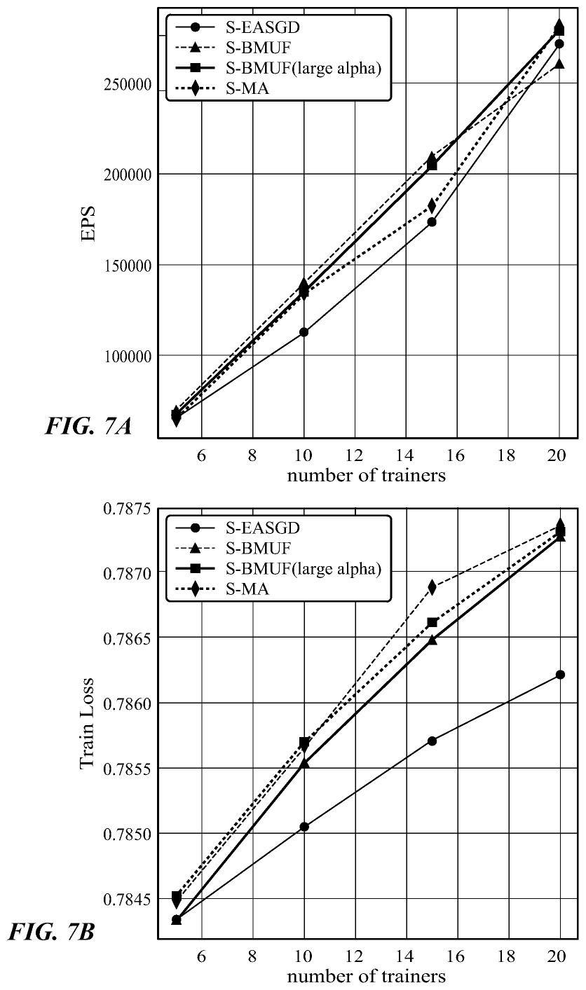

The embodiments disclosed herein present a similar but simplified experiment for BMUF and MA type of algorithms. We apply the fixed rate and ShadowSync versions of those algorithm to training Model-B on Dataset-2, where the number of trainers is 5, 10, 15, and 20 respectively. We inspected the average sync rate of S-BMUF, which was 2 syncs per minute for 5 trainers and 0.8 for 20 trainers. For S-MA, the numbers were 2.9 and 1.0. We then set the sync rate of FR-BMUF and FR-MA to be 1 per minute. FIG. 6A illustrates example model quality of BMUF and MA under the disclosed framework and fixed rate frameworks for training Model-B on Dataset-2. The losses are reported in FIG. 6A. The performance of ShadowSync algorithms are comparable and even superior to the fixed rate versions. FIG. 6B illustrates example EPS scaling of BMUF and MA algorithms. Here the synchronization is not a bottleneck for all the experiments, and all the algorithms can scale linearly.

S-EASGD is a representative centralized algorithm, where the parameter exchange happens in a single location. One shortcoming of S-EASGD may be that it may require extra machines for synchronization purpose only, and the number of sync PSs may need to increase if we want to further reduce the sync gap. In contrast, for decentralized algorithms the synchronization happens across trainers directly. S-BMUF and S-MA are two instances under ShadowSync framework. We are thus interested in comparing S-BMUF and S-MA to S-EASGD.

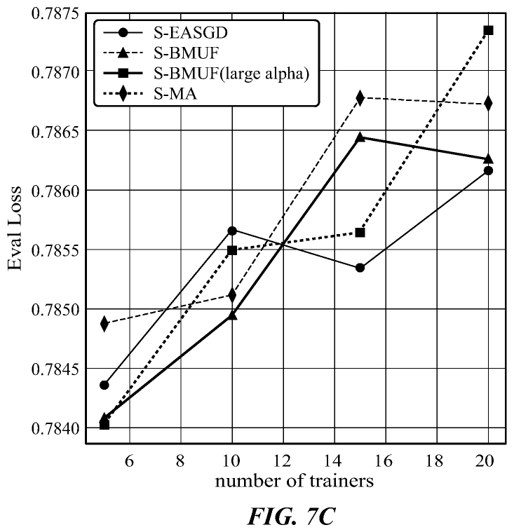

We applied those methods to training Model-B on Dataset-2, using 5, 10, 15 and 20 trainers. The number of embedding PSs is the same as the number of trainers, and we use 2 sync PSs for S-EASGD. The same hyper-parameters are deployed to all 3 methods. One exception we made is the elastic parameter a for S-BMUF. S-BMUF tends to update the model more conservatively than S-MA: it may make a step towards to average model rather than taking it directly. In light of this, we hypothesized S-BMUF may converge slower than S-MA. Hence, in addition to the standard a used before, we tested a larger value for it to make more aggressive parameter sharing. FIG. 7A illustrates example performance of S-EASGD for training Model-B on Dataset-2. FIG. 7B illustrates example performance of S-BMUF for training Model-B on Dataset-2. FIG. 7C illustrates example performance of S-MA for training Model-B on Dataset-2.

Increasing a does improve the performance of S-BMUF. S-EASGD has best training performance, followed by S-BMUF with larger elastic parameter. However, the evaluation performance is mixed. None of those algorithm stands at the leading place. To summarize, our experiments suggest that S-BMUF and S-MA may be capable to perform comparably good as S-EASGD.

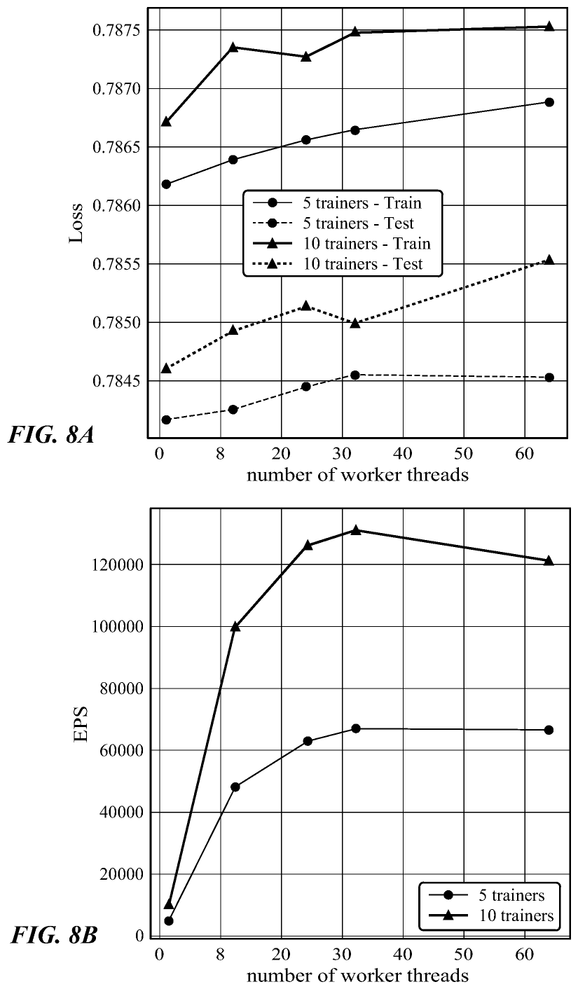

Finally, we justify the usage of 24 worker threads with Hogwild update throughout our experiments. We shall train Model-C on Dataset-3 using S-EASGD. This dataset contains 1,967,190,757 training samples and 4,709,234,620 evaluation samples. The baseline of our experiment is S-EASGD using single-thread training. For Hogwild, we tried 12, 24, 32 and 64 worker threads. All hyper-parameters are set to be the same. We run this experiment under 5-trainer and 10-trainer setup, respectively. For 5-trainer training, we use 1 sync PS, and 4 embedding PSs. For 10-trainer training, we use 1 sync PS and 6 embedding PSs. FIG. 8A illustrates example performance of S-EASGD based on loss with varying number of worker threads for training Model-C on Dataset-3 FIG. 8B illustrates example performance of S-EASGD based on EPS with varying number of worker threads for training Model-C on Dataset-3. FIG. 8A plots training and evaluation losses versus the number of worker threads. We do observe an increasing pattern. However, the quality drop is mild compared to the EPS gain, plotted in FIG. 8B. FIG. 8B also shows the EPS almost stops growing when 24 or more threads are used, for both 5-trainer and 10-trainer cases. We find that the trainers became the bottleneck in those cases, as the memory bandwidth is saturated (the interaction layers are memory bandwidth demanding). With 12 worker threads, the memory bandwidth utilization is around 50%. After we double the number of worker threads to be 24, we already saturate the memory bandwidth: the average utilization is around 70%, while some hot trainers have 89% utilization.

The embodiments disclosed herein described a new framework that synchronizes parameters in the background. This framework isolates training from synchronization. The embodiments disclosed herein described the ShadowSync EASGD, ShadowSync BMUF, and ShadowSync MA algorithms under this framework, and have shown that these algorithms can scale linearly with similar or better model quality compared to their foreground variants. The embodiments disclosed herein also described how we integrate the new framework into our distributed training system, which expresses both model parallelism and data parallelism (with both Hogwild parallelism and replication parallelism) to accomplish the extremely high ELP numbers.

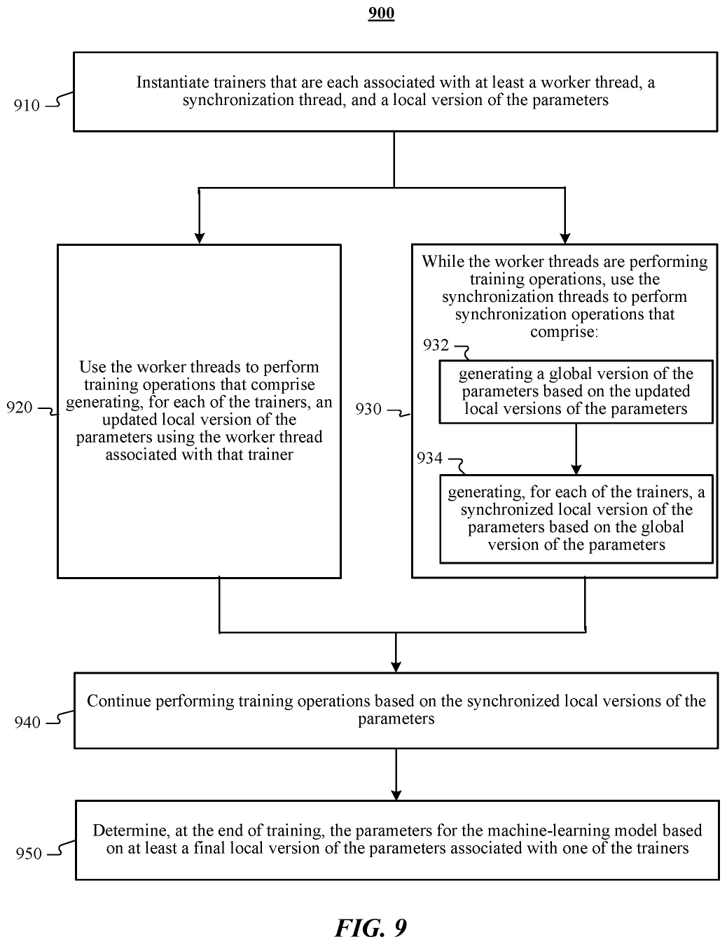

FIG. 9 illustrates an example method 900 for training a machine-learning model having a plurality of parameters. The method may begin at step 910, where a computing system may instantiate trainers that are each associated with at least a worker thread, a synchronization thread, and a local version of the parameters. At step 920, the computing system may use the worker threads to perform training operations that comprise generating, for each of the trainers, an updated local version of the parameters using the worker thread associated with that trainer. At step 930, the computing system may, while the worker threads are performing training operations, use the synchronization threads to perform synchronization operations. The synchronization operations may comprise the following sub-steps. At sub-step 932, the computing system may generate a global version of the parameters based on the updated local versions of the parameters. At sub-step 934, the compute system may generate, for each of the trainers, a synchronized local version of the parameters based on the global version of the parameters. At step 940, the computing system may continue performing training operations based on the synchronized local versions of the parameters. At step 950, the computing system may determine, at the end of training, the parameters for the machine-learning model based on at least a final local version of the parameters associated with one of the trainers. Particular embodiments may repeat one or more steps of the method of FIG. 9, where appropriate. Although this disclosure describes and illustrates particular steps of the method of FIG. 9 as occurring in a particular order, this disclosure contemplates any suitable steps of the method of FIG. 9 occurring in any suitable order. Moreover, although this disclosure describes and illustrates an example method for training a machine-learning model having a plurality of parameters including the particular steps of the method of FIG. 9, this disclosure contemplates any suitable method for training a machine-learning model having a plurality of parameters including any suitable steps, which may include all, some, or none of the steps of the method of FIG. 9, where appropriate. Furthermore, although this disclosure describes and illustrates particular components, devices, or systems carrying out particular steps of the method of FIG. 9, this disclosure contemplates any suitable combination of any suitable components, devices, or systems carrying out any suitable steps of the method of FIG. 9.

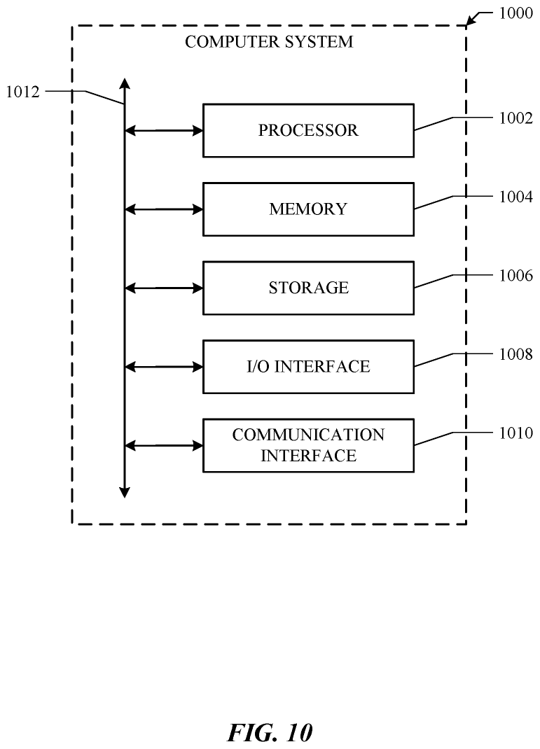

FIG. 10 illustrates an example computer system 1000. In particular embodiments, one or more computer systems 1000 perform one or more steps of one or more methods described or illustrated herein. In particular embodiments, one or more computer systems 1000 provide functionality described or illustrated herein. In particular embodiments, software running on one or more computer systems 1000 performs one or more steps of one or more methods described or illustrated herein or provides functionality described or illustrated herein. Particular embodiments include one or more portions of one or more computer systems 1000. Herein, reference to a computer system may encompass a computing device, and vice versa, where appropriate. Moreover, reference to a computer system may encompass one or more computer systems, where appropriate.

This disclosure contemplates any suitable number of computer systems 1000. This disclosure contemplates computer system 1000 taking any suitable physical form. As example and not by way of limitation, computer system 1000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1000 may include one or more computer systems 1000; be unitary or distributed; span multiple locations; span multiple machines; span multiple data centers; or reside in a cloud, which may include one or more cloud components in one or more networks. Where appropriate, one or more computer systems 1000 may perform without substantial spatial or temporal limitation one or more steps of one or more methods described or illustrated herein. As an example and not by way of limitation, one or more computer systems 1000 may perform in real time or in batch mode one or more steps of one or more methods described or illustrated herein. One or more computer systems 1000 may perform at different times or at different locations one or more steps of one or more methods described or illustrated herein, where appropriate.

In particular embodiments, computer system 1000 includes a processor 1002, memory 1004, storage 1006, an input/output (I/O) interface 1008, a communication interface 1010, and a bus 1012. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage 1006; decode and execute them; and then write one or more results to an internal register, an internal cache, memory 1004, or storage 1006. In particular embodiments, processor 1002 may include one or more internal caches for data, instructions, or addresses. This disclosure contemplates processor 1002 including any suitable number of any suitable internal caches, where appropriate. As an example and not by way of limitation, processor 1002 may include one or more instruction caches, one or more data caches, and one or more translation lookaside buffers (TLBs). Instructions in the instruction caches may be copies of instructions in memory 1004 or storage 1006, and the instruction caches may speed up retrieval of those instructions by processor 1002. Data in the data caches may be copies of data in memory 1004 or storage 1006 for instructions executing at processor 1002 to operate on; the results of previous instructions executed at processor 1002 for access by subsequent instructions executing at processor 1002 or for writing to memory 1004 or storage 1006; or other suitable data. The data caches may speed up read or write operations by processor 1002. The TLBs may speed up virtual-address translation for processor 1002. In particular embodiments, processor 1002 may include one or more internal registers for data, instructions, or addresses. This disclosure contemplates processor 1002 including any suitable number of any suitable internal registers, where appropriate. Where appropriate, processor 1002 may include one or more arithmetic logic units (ALUs); be a multi-core processor; or include one or more processors 1002. Although this disclosure describes and illustrates a particular processor, this disclosure contemplates any suitable processor.

In particular embodiments, memory 1004 includes main memory for storing instructions for processor 1002 to execute or data for processor 1002 to operate on. As an example and not by way of limitation, computer system 1000 may load instructions from storage 1006 or another source (such as, for example, another computer system 1000) to memory 1004. Processor 1002 may then load the instructions from memory 1004 to an internal register or internal cache.

To execute the instructions, processor 1002 may retrieve the instructions from the internal register or internal cache and decode them. During or after execution of the instructions, processor 1002 may write one or more results (which may be intermediate or final results) to the internal register or internal cache. Processor 1002 may then write one or more of those results to memory 1004. In particular embodiments, processor 1002 executes only instructions in one or more internal registers or internal caches or in memory 1004 (as opposed to storage 1006 or elsewhere) and operates only on data in one or more internal registers or internal caches or in memory 1004 (as opposed to storage 1006 or elsewhere). One or more memory buses (which may each include an address bus and a data bus) may couple processor 1002 to memory 1004. Bus 1012 may include one or more memory buses, as described below. In particular embodiments, one or more memory management units (MMUs) reside between processor 1002 and memory 1004 and facilitate accesses to memory 1004 requested by processor 1002. In particular embodiments, memory 1004 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1004 may include one or more memories 1004, where appropriate. Although this disclosure describes and illustrates particular memory, this disclosure contemplates any suitable memory.

In particular embodiments, storage 1006 includes mass storage for data or instructions. As an example and not by way of limitation, storage 1006 may include a hard disk drive (HDD), a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 may be internal or external to computer system 1000, where appropriate. In particular embodiments, storage 1006 is non-volatile, solid-state memory. In particular embodiments, storage 1006 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1006 taking any suitable physical form. Storage 1006 may include one or more storage control units facilitating communication between processor 1002 and storage 1006, where appropriate. Where appropriate, storage 1006 may include one or more storages 1006. Although this disclosure describes and illustrates particular storage, this disclosure contemplates any suitable storage.

In particular embodiments, I/O interface 1008 includes hardware, software, or both, providing one or more interfaces for communication between computer system 1000 and one or more I/O devices. Computer system 1000 may include one or more of these I/O devices, where appropriate. One or more of these I/O devices may enable communication between a person and computer system 1000. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1008 for them. Where appropriate, I/O interface 1008 may include one or more device or software drivers enabling processor 1002 to drive one or more of these I/O devices. I/O interface 1008 may include one or more I/O interfaces 1008, where appropriate. Although this disclosure describes and illustrates a particular I/O interface, this disclosure contemplates any suitable I/O interface.

In particular embodiments, communication interface 1010 includes hardware, software, or both providing one or more interfaces for communication (such as, for example, packet-based communication) between computer system 1000 and one or more other computer systems 1000 or one or more networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1010 for it. As an example and not by way of limitation, computer system 1000 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1000 may include any suitable communication interface 1010 for any of these networks, where appropriate. Communication interface 1010 may include one or more communication interfaces 1010, where appropriate. Although this disclosure describes and illustrates a particular communication interface, this disclosure contemplates any suitable communication interface.

In particular embodiments, bus 1012 includes hardware, software, or both coupling components of computer system 1000 to each other. As an example and not by way of limitation, bus 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1012 may include one or more buses 1012, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method for training a machine-learning model having a plurality of parameters, comprising:
instantiating trainers that are each associated with at least a worker thread, a synchronization thread, and a local version of the parameters;
using the worker threads to perform training operations that comprise generating, for each of the trainers, an updated local version of the parameters using the worker thread associated with that trainer;
while the worker threads are performing training operations, using the synchronization threads to perform synchronization operations that comprise:
generating a global version of the parameters based on the updated local versions of the parameters; and
generating, for each of the trainers, a synchronized local version of the parameters based on the global version of the parameters;
continuing performing training operations based on the synchronized local versions of the parameters; and
determining, at the end of training, the parameters for the machine-learning model based on at least a final local version of the parameters associated with one of the trainers.

2. The method of claim 1, wherein generating the global version of the parameters based on the updated local versions of the parameters comprises:
communicating the updated local versions of the parameters to one or more synchronization parameter servers; and
synchronizing, at the one or more synchronization parameter servers, the updated local versions of the parameters to generate the global version of the parameters.

3. The method of claim 2, further comprising:
partitioning the plurality of parameters into one or more shards corresponding to the one or more synchronization parameter servers.

4. The method of claim 2, wherein generating the synchronized local version of the parameters for each of the trainers comprises:
communicating, from the one or more synchronization parameter servers to that trainer, the global version of the parameters.

5. The method of claim 1, wherein generating the global version of the parameters based on the updated local versions of the parameters is based on communications between each of the synchronization threads.

6. The method of claim 1, wherein generating the global version of the parameters based on the updated local versions of the parameters is based on one or more synchronization algorithms, wherein each of the one or more synchronization algorithm is predetermined independently from the machine-learning model.

7. The method of claim 1, further comprising:
generating, by a master, a plurality of partitions of the training of the machine-learning model; and
sending, by the master to each of the trainers, a distinct execution plan for that trainer, wherein the distinct execution plan is determined based on the plurality of partitions.

8. The method of claim 1, wherein determining the parameters for the machine-learning model is further based on an average of all final local versions of the parameters associated with all the trainers.

9. The method of claim 1, wherein the trainers are associated with a shared reader service, wherein the shared reader service converts a training example to a feature representation used for training the machine-learning model.

10. The method of claim 9, wherein training the machine-learning model is based on a plurality of training examples, wherein generating the updated local version of the parameters for each of the trainers using the worker thread associated with that trainer comprises:
partitioning the plurality of training examples into a plurality of batches of training examples;
accessing one batch of feature representations corresponding to one batch of the plurality of batches of training examples; and
generating the updated local version of the parameters based on the accessed batch of feature representations.

11. One or more computer-readable non-transitory storage media embodying software that is operable when executed to train a machine-learning model having a plurality of parameters, wherein the training comprises:
instantiating trainers that are each associated with at least a worker thread, a synchronization thread, and a local version of the parameters;
using the worker threads to perform training operations that comprise generating, for each of the trainers, an updated local version of the parameters using the worker thread associated with that trainer;
while the worker threads are performing training operations, using the synchronization threads to perform synchronization operations that comprise:
generating a global version of the parameters based on the updated local versions of the parameters; and
generating, for each of the trainers, a synchronized local version of the parameters based on the global version of the parameters;
continuing performing training operations based on the synchronized local versions of the parameters; and
determining, at the end of training, the parameters for the machine-learning model based on at least a final local version of the parameters associated with one of the trainers.

12. The media of claim 11, wherein generating the global version of the parameters based on the updated local versions of the parameters comprises:
communicating the updated local versions of the parameters to one or more synchronization parameter servers; and
synchronizing, at the one or more synchronization parameter servers, the updated local versions of the parameters to generate the global version of the parameters.

13. The media of claim 12, wherein the training further comprises:
partitioning the plurality of parameters into one or more shards corresponding to the one or more synchronization parameter servers.

14. The media of claim 12, wherein generating the synchronized local version of the parameters for each of the trainers comprises:
communicating, from the one or more synchronization parameter servers to that trainer, the global version of the parameters.

15. The media of claim 11, wherein generating the global version of the parameters based on the updated local versions of the parameters is based on communications between each of the synchronization threads.

16. The media of claim 11, wherein generating the global version of the parameters based on the updated local versions of the parameters is based on one or more synchronization algorithms, wherein each of the one or more synchronization algorithm is predetermined independently from the machine-learning model.

17. The media of claim 1, wherein the training further comprises:
generating, by a master, a plurality of partitions of the training of the machine-learning model; and
sending, by the master to each of the trainers, a distinct execution plan for that trainer, wherein the distinct execution plan is determined based on the plurality of partitions.

18. The media of claim 11, wherein determining the parameters for the machine-learning model is further based on an average of all final local versions of the parameters associated with all the trainers.

19. The media of claim 11, wherein the trainers are associated with a shared reader service, wherein the shared reader service converts a training example to a feature representation used for training the machine-learning model.

20. A system comprising: one or more processors; and a non-transitory memory coupled to the processors comprising instructions executable by the processors, the processors operable when executing the instructions to train a machine-learning model having a plurality of parameters, wherein the training comprises:
instantiating trainers that are each associated with at least a worker thread, a synchronization thread, and a local version of the parameters;
using the worker threads to perform training operations that comprise generating, for each of the trainers, an updated local version of the parameters using the worker thread associated with that trainer;
while the worker threads are performing training operations, using the synchronization threads to perform synchronization operations that comprise:
generating a global version of the parameters based on the updated local versions of the parameters; and
generating, for each of the trainers, a synchronized local version of the parameters based on the global version of the parameters;
continuing performing training operations based on the synchronized local versions of the parameters; and
determining, at the end of training, the parameters for the machine-learning model based on at least a final local version of the parameters associated with one of the trainers.
